(19) United States
(12) Patent Application Publication
(10) Pub. No.: US 2024/0412073 A1
(43) Pub. Date: Dec. 12, 2024

(54) METHOD FOR CONFIGURING A DATA PROCESSING CHAIN

(71) Applicant: ATOS FRANCE, Bezons (FR)

(72) Inventors: Yannick LECROART, La Grand Motte (FR); Nelson ROGERS, Castelnau-Le-Lez (FR)

(73) Assignee: ATOS FRANCE, Bezons (FR)

(21) Appl. No.: 18/735,291

(22) Filed: Jun. 6, 2024

(30) Foreign Application Priority Data
Jun. 6, 2023 (EP) 23305900.5

(51) Int. Cl. G06N 3/092

(52) U.S. Cl. CPC G06N 3/092

(57) ABSTRACT

The invention relates to a method for configuring a data processing chain implementing a current artificial intelligence model associated with a current accuracy score. The configuring method including an implementation of a reinforcement algorithm that includes selecting a dataset according to an associated reward; training an artificial intelligence model on the basis of the selected dataset to obtain an experimental artificial intelligence model; calculating an experimental accuracy score for the experimental artificial intelligence model. In addition, based on the result of a comparison between the current accuracy score and the experimental accuracy score, the configuring method also includes either replacing or not replacing the current artificial intelligence model with the experimental artificial intelligence model; and updating the reward associated with the selected dataset.

This application claims priority to European Patent Application Number 23305900.5, filed 6 Jun. 2023, the specification of which is hereby incorporated herein by reference.

### BACKGROUND OF THE INVENTION

### Field of the Invention

At least one embodiment of the invention relates to a method for configuring a data processing chain.

At least one embodiment of the invention also relates to a computer program and to a device implementing such a method.

At least one embodiment of the invention applies to the field of predictive maintenance.

### Description of the Related Art

When implementing an IoT (Internet of Things) project, it is known to place connected objects, in particular sensors, in a given environment to be monitored (for example, an installation), in order to make it “smart”, that is capable of sending back data (such as measurements) representative of events taking place there.

Furthermore, it is known to implement predictive maintenance strategies to anticipate possible anomalies within the environment, specific to said objects (for example, malfunctions), so as to prevent breakdowns and limit downtime. In this way, the connected objects become part of a predictive maintenance system.

However, such predictive maintenance systems are not entirely satisfactory.

In fact, known predictive maintenance systems are liable to provide false positives, that is to predict the occurrence of an anomaly within the monitored installation on the basis of data reported by one or more sensor(s), even though said monitored installation is actually behaving normally. This leads to untimely on-site interventions by operators in charge of plant maintenance.

However, physical access to all or some of the plant is sometimes complex, for example due to the nature and profile of the land wherein it is located (sewers, pipes, turbines, etc.). Such interventions are therefore time-consuming and costly, and are likely to lead to write-offs for the operator. Furthermore, they result in needless inconvenience for operators.

Such false positives are also likely to trigger interventions requiring the plant to be shut down for maintenance, resulting in additional financial losses.

Consequently, the cost inherent in managing and maintaining an IoT project is a real issue for local authorities and businesses, as this cost is likely to compromise the project's profitability.

One aim of one or more embodiments of the invention is to solve at least one of the shortcomings of the state of the art.

Another aim of at least one embodiment of the invention is to offer a predictive maintenance solution that has a better ability to predict anomalies than existing solutions.

### BRIEF SUMMARY OF THE INVENTION

To this end, at least one embodiment of the invention relates to a method of the aforementioned type, the processing chain comprising a prediction stage implementing a current artificial intelligence model, previously trained on the basis of a training dataset, to predict an anomaly in a monitored environment equipped with at least one sensor, from input data received from each sensor,
the current artificial intelligence model being associated with a current accuracy score, representative of a match between, on the one hand, a first predicted state of the monitored environment, determined by the current artificial intelligence model from test data dependent on input data, and, on the other hand, an actual state of the monitored environment for said test data,
the configuring method being computer-implemented and comprising an implementation of a reinforcement algorithm comprising the steps of:
   selecting a dataset from a set of datasets stored in a memory, according to a reward associated with each dataset;
   training an artificial intelligence model on the basis of the selected dataset to obtain an experimental artificial intelligence model;
   calculating an experimental accuracy score of the experimental artificial intelligence model, representative of a match between, on the one hand, a second predicted state of the monitored environment, determined by the experimental artificial intelligence model from the test data, and, on the other hand, the actual state of the monitored environment for the test data; and
   based on the result of a comparison between the current accuracy score and the experimental accuracy score:
   either replacing or not replacing the current artificial intelligence model with the experimental artificial intelligence model in the prediction stage; and
   updating the reward associated with the selected dataset.

Indeed, such a method results in continuous optimization of the artificial intelligence model used for anomaly prediction, making it more reliable than existing solutions.

Furthermore, thanks to the implementation of a reinforcement algorithm, the artificial intelligence model is trained on the basis of the dataset that leads to the most accurate results with regard to the test data, which depend on the input data, that is the data actually fed back by the sensors. There is therefore no need for a human agent to set up and modify, over time, explicit rules relating to the datasets on the basis of which the artificial intelligence models are to be trained, which makes the method according to one or more embodiments of the invention extremely simple to implement.

Advantageously, the method according to at least one embodiment of the invention has one or more of the following characteristics, taken individually or in any technically possible combination:
if the experimental accuracy score is higher than the current accuracy score:
the current artificial intelligence model is replaced by the experimental artificial intelligence model; and
the update of the reward associated with the selected dataset is an increase of said reward;
if the experimental accuracy score is lower than the current accuracy score:
the current artificial intelligence model is not replaced by the experimental artificial intelligence model;
the update of the reward associated with the selected dataset is a decrease of said reward;
the selected dataset is the dataset associated with the maximum reward;
the configuring method further comprises the steps of:
comparing a current predicted state of the monitored environment, predicted by the current artificial intelligence model from the input data, with an actual state of the monitored environment; and
updating the test data based on a comparison result;
updating the test data comprises adding to the test data some or all of the input data from which the current predicted state was determined, together with a label representative of whether the prediction is correct or incorrect.
the configuring method further comprises the steps of:
comparing a current predicted state of the monitored environment, predicted by the current artificial intelligence model from the input data, with an actual state of the monitored environment;
in the event of a discrepancy between the current predicted state and the actual state of the monitored environment, creating an additional dataset by modifying the dataset on the basis of which the current artificial intelligence model was trained, from the predicted state and the actual state; and
storing the created dataset in memory;
the additional dataset created comprises the data of the dataset on the basis of which the current artificial intelligence model has been trained, to which has been added the input data from which the current predicted state has been determined, associated with a label representative of whether the prediction is correct or incorrect;
upon its creation, the dataset created is associated with a reward having a value greater than the value of the reward associated with each other dataset stored in the memory;
the configuring method further comprises the steps of:
selecting at least some of the input data, preferably by implementing a feature selection process, to generate at least one additional dataset; and
storing the generated dataset in memory;
the reinforcement algorithm is a Q-learning algorithm, a Deep Q-Learning algorithm, or a neural network.

According to one or more embodiments of the invention, a computer program is proposed which comprises executable instructions that, when executed by computer, implement the steps of the method as defined hereinbefore.

The computer program can be in any computer language, such as for example machine language, C, C++, JAVA, Python, etc.

According to at least one embodiment of the invention, a device for configuring a data processing chain is proposed, the processing chain comprising a prediction stage implementing a current artificial intelligence model, previously trained on the basis of a training dataset, to predict an anomaly in a monitored environment equipped with at least one sensor, from input data received from each sensor,
the current artificial intelligence model being associated with a current accuracy score, representative of a match between, on the one hand, a first predicted state of the monitored environment, determined by the current artificial intelligence model from test data dependent on input data, and, on the other hand, an actual state of the monitored environment for said test data, the configuring device being configured to implement a reinforcement algorithm comprising the steps of:
   selecting a dataset from a set of datasets stored in a memory, according to a reward associated with each dataset;
   training an artificial intelligence model on the basis of the selected dataset to obtain an experimental artificial intelligence model;
   calculating an experimental accuracy score of the experimental artificial intelligence model, representative of a match between, on the one hand, a second predicted state of the monitored environment, determined by the experimental artificial intelligence model from the test data, and, on the other hand, the actual state of the monitored environment for the test data; and
   based on the result of a comparison between the current accuracy score and the experimental accuracy score:
   either replacing or not replacing the current artificial intelligence model with the experimental artificial intelligence model in the prediction stage; and
   updating the reward associated with the selected dataset.

The device according to at least one embodiment of the invention can be any type of device such as a server, a computer, a tablet, a calculator, a processor, a computer chip, programmed to implement the method according to one or more embodiments of the invention, for example by executing the computer program according to at least one embodiment of the invention.

### BRIEF DESCRIPTION OF THE DRAWINGS

The invention will be better understood on reading the following description, given solely by way of non-limiting example and with reference to the accompanying drawings, wherein:

FIG. 1 is a schematic depiction of a processing chain associated with a configuring device according to one or more embodiments of the invention;

FIG. 2 is a flowchart of a configuring method implemented by the device of FIG. 1, according to one or more embodiments of the invention.

### DETAILED DESCRIPTION OF THE INVENTION

It is understood that the one or more embodiments which will be described hereinafter are in no way limiting. It will in particular be possible to imagine variants of the one or more embodiments of the invention comprising only a selection of features described below isolated from the other features described, if this selection of features is sufficient to confer a technical advantage or to differentiate the one or more embodiments of the invention from the prior art. This selection comprises at least one preferably functional feature without structural details, or with only a part of the structural details if this part is only sufficient to confer a technical advantage or to differentiate the at least one embodiment of the invention from the prior art.

In particular, all the variants and all the embodiments described can be combined with one another, provided there are no technical obstacles to such combination.

In the figures and in the rest of the description, the elements common to multiple figures retain the same reference.

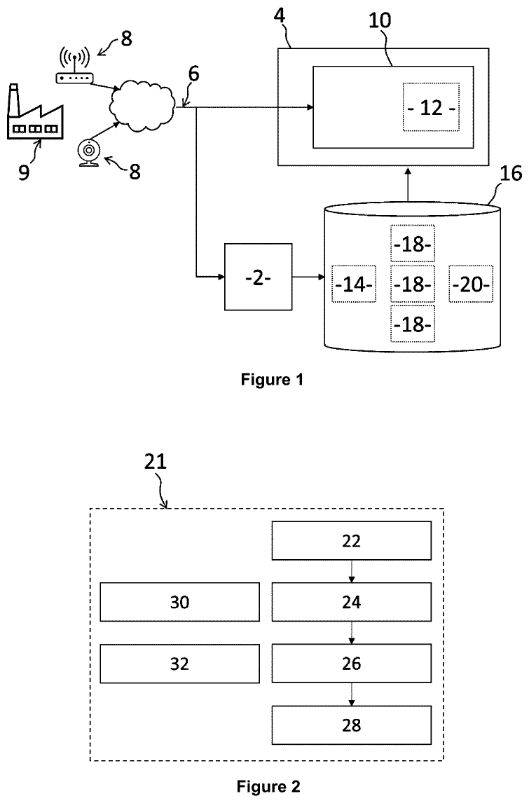

A configuring device 2 according to at least one embodiment of the invention, for the configuring of a data processing chain 4 (subsequently called the “processing chain”), is shown by FIG. 1.

The processing chain 4 is configured to process an input data stream 6 (also called “input data”) received from at least one sensor 8, in particular from at least one connected object.

Each sensor 8 is designed to monitor a predetermined environment 9 (known as the “monitored environment”), such as a plant, machine, or device. More specifically, the input data 6 comprises measurements and observations representative of a state of the monitored environment 9.

The processing chain 4 comprises a prediction stage 10 adapted, in operation, to implement a current artificial intelligence model 12 in order to predict, from the input data 6, the occurrence of an anomaly in the monitored environment 9. More generally, the prediction stage 10 is preferably configured to implement the current artificial intelligence model 12 in order to predict, from the input data 6, a future state of the monitored environment 9, referred to as the “current predicted state”.

The current artificial intelligence model 12 was previously trained on the basis of a corresponding training dataset.

Furthermore, the current artificial intelligence model is associated with a current accuracy score Pc, representative of a match between, on the one hand, a first predicted state of the monitored environment, determined by the current artificial intelligence model 12 from test data 14 dependent on the input data 6, and, on the other hand, an actual state of the monitored environment 9 for said test data (that is a state of the monitored environment 9 for which the input data 6 are identical to the test data).

The evolution of such test data over time will be described later.

The configuring device 2 is intended to modify a configuration of the processing chain 4, and more particularly of its prediction stage 10. More specifically, the configuring device 2 is intended to modify the configuration of the processing chain 4 according to the predictions made by the processing chain 4 based on the input data stream 6.

The configuring device 2 may be in hardware form, such as a computer, a server, a processor, an electronic chip, etc. Alternatively, or additionally, the configuring device 2 may be in software form, such as a computer program, or an application, for example an application for a user device such as a tablet or smartphone.

The configuring device 2 is associated with a memory 16 configured to store the test data 14.

The memory 16 is also configured to store at least one dataset 18. Each dataset 18 is associated with a respective reward, also stored in the memory 16. How such datasets 18 are obtained will be described later.

Furthermore, the memory 16 is configured to store at least one artificial intelligence 20 model, referred to as “experimental”. Each experimental artificial intelligence model 20 has been previously trained on the basis of a corresponding dataset 18 from the set of datasets 18 stored in memory 16.

To configure the processing chain 4, the configuring device 2 is configured to implement a configuring method 21, schematically shown by FIG. 2, according to one or more embodiments of the invention.

The configuring procedure 21 can be implemented several times, successively over time.

As shown in the figure, the configuring method 21 comprises implementing a reinforcement algorithm comprising a dataset selection step 22 (referred to as the “selection step”), a training step 24, an accuracy score calculation step 26 (referred to as the “calculation step”) and a configuration step 28 in succession.

Optionally, the configuring method 21 also comprises a step 30 for enriching test data (known as the “enrichment step”) and/or a step 32 for generating datasets (known as the “generation step”).

Preferably, the reinforcement algorithm implemented by the configuring device 2 during the execution of the configuring method 21 is a Q-learning algorithm, a Deep Q-Learning algorithm or a neural network.

### Dataset Selection

The configuring device 2 is configured to select, during selection step 22, a dataset 18 from the set of datasets 18 stored in memory 16. This selection is made on the basis of the reward associated with each dataset 18.

For example, if an administrator has configured the configuring device 2 to adopt an “optimal choice” strategy, the configuring device 2 is configured to select the dataset 18 associated with the maximum reward.

However, other strategies are also likely to be adopted. For example, the configuring device 2 can be configured to adopt an “exploratory” strategy. In this case, the configuring device 2 is configured to select a dataset 18 that is not necessarily associated with the maximum reward. The choice between an optimal choice strategy and an exploratory strategy depends, for example, on factors such as a variable following a probability law (such as a Bernoulli distribution) or the occurrence of an event, depending on the specific task in question.

### Training

Furthermore, the configuring device 2 is configured to train an artificial intelligence model based on the selected dataset 18, during the training step 24. In this way, an experimental artificial intelligence model 20 is obtained.

The configuring device 2 is also configured to store the obtained experimental artificial intelligence model 20 in the memory 16.

The artificial intelligence model used in the training step 24 is likely to be any artificial intelligence model known to the person skilled in the art, such as a neural network.

### Accuracy Score Calculation

Furthermore, the configuring device 2 is configured to calculate, in the calculation step 26, an experimental accuracy score PE of the experimental artificial intelligence model 20 obtained at the end of the training step 24.

The experimental accuracy score PE is representative of a match between, on the one hand, a second predicted state of the monitored environment, determined by the experimental artificial intelligence model 20 from the test data 14, and, on the other hand, the actual state of the monitored environment 9 for the test data (that is a state of the monitored environment 9 for which the input data 6 is identical to the test data).

### Configuration

Furthermore, the configuring device 2 is adapted to configure, during the configuration step 28, the processing chain 4 according to the experimental accuracy score PE determined at the end of the calculation step 26.

More specifically, the configuring device 2 is configured to compare the current accuracy score Pc and the experimental accuracy score PE.

Furthermore, the configuring device 2 is configured to, depending on the result of the comparison:
issue a command to either replace or not replace the current artificial intelligence model 12 with the experimental artificial intelligence model 20 in the prediction stage 10; and
update the reward associated with the selected dataset 18.

Advantageously, if the experimental accuracy score is higher than the current accuracy score, the configuring device 2 is preferably configured to:
issue a command to replace the current artificial intelligence model 12 with the experimental artificial intelligence model 20; and
increase the reward associated with the dataset 18 selected in the selection step 22, on the basis of which the experimental artificial intelligence model 20 was obtained.

This is advantageous, as the artificial intelligence model implemented by the processing chain is the best-performing model with regard to the test data.

Advantageously, if the experimental accuracy score PE is strictly lower than the current accuracy score Pc, the configuring device 2 is configured to:
issue a command to keep the current artificial intelligence model 12 as the artificial intelligence model implemented by the prediction stage 10 of the processing chain 4; and
decrease the reward associated with the dataset 18 selected in the selection step 22, on the basis of which the experimental artificial intelligence model 20 was obtained.

This is advantageous, as the dataset 18 that led to a poorly performing trained model will be less likely to be selected during a subsequent iteration of the configuring method 21.

### Test Data Enrichment

As mentioned previously, the configuring method 21 advantageously includes the enrichment step 30, according to one or more embodiments of the invention.

Preferably, the configuring device 2 is configured to implement the enrichment step 30 following an intervention triggered by a prediction, by the current artificial intelligence model 12 of the processing chain 4, of the occurrence of an anomaly.

More specifically, when an operator is sent on site to deal with an anomaly predicted by processing chain 4, the operator is asked to provide feedback on this intervention: the operator indicates whether or not this intervention was justified, that is whether or not the anomaly prediction was erroneous.

In particular, the configuring device 2 is configured to, during the enrichment step 30, compare a current predicted state of the monitored environment 9, predicted by the current artificial intelligence model 12 from the input data 6, with an actual state of the monitored environment.

Furthermore, the configuring device 2 is configured to update the test data 14 based on a comparison result.

In this case, the configuring device 2 is configured to enrich the test data by including the input data 6 on the basis of which the maintenance operation was triggered, associated with a label representative of whether the prediction was correct or erroneous (that is representative of whether the predicted anomaly was proven or not).

More generally, the configuring device 2 is configured to implement the enrichment step 30 each time the actual state of the monitored environment 9 is observed. In this case, the configuring device 2 is configured to enrich the test data by including input data 6 on the basis of which a state of the monitored environment 9, at the time of said observation, had been predicted by the current artificial intelligence model 12. In this case, the input data 6 is associated with a label representative of whether the prediction is correct or incorrect, the label being determined by said observation of the actual state of the monitored environment 9.

### Generating Datasets

As mentioned previously, the configuring method 21 may also include the generation step 32.

Preferably, the configuring device 2 is configured to implement the generation step 32 following observation of the actual state of the monitored environment 9. Such an observation is, for example, the result of an intervention, at the level of the monitored environment 9, triggered by a prediction of an anomaly by the current artificial intelligence model 12 of the processing chain 4.

In particular, the configuring device 2 is configured to generate, in the generation step 32, at least one new dataset 18 from the datasets 18 stored in the memory 16.

In particular, the configuring device 2 is configured to, during the generation step 32, compare a current predicted state of the monitored environment 9, predicted by the current artificial intelligence model 12 from the input data 6, with an actual state of the monitored environment.

Furthermore, in the event of a mismatch between the current predicted state and the actual state of the monitored environment 9, the configuring device 2 is configured to create an additional dataset 18 by modifying the dataset on the basis of which the current artificial intelligence model 12 has been trained (the so-called “current training dataset”).

In particular, the configuring device 2 is configured to modify the current training dataset to include the input data 6 on the basis of which the current predicted state was determined, associated with a label representative of whether the prediction was correct or incorrect (that is representative of a match or mismatch between the current predicted state and the actual observed state).

The configuring device 2 is also configured to store the additional dataset 18 thus created in the memory 16.

Advantageously, in this case, the configuring device 2 is configured to associate the created dataset 18, when it is created, with a reward having a value greater than the value of the reward associated with each other dataset 18 stored in the memory 16.

Optionally, the configuring device 2 is configured to generate, during the generation step 32, at least one new dataset 18 from the input data 6.

In this case, the configuring device 2 is configured to apply a selection process to the input data 6 in order to extract so-called “useful” data. By “useful data”, we mean data providing information that is relevant to the predictions to be made, that is enabling the artificial intelligence model to make reliable predictions.

To extract the useful data, the configuring device 2 is, in particular, configured to implement a feature selection process. Such a process is based, for example, on the use of statistical analysis such as the χ² (Chi-2) test, or mutual information.

The configuring device 2 is also configured to store the additional dataset 18 thus created in the memory 16.

### Operation

The operation of the configuring device 2 will now be described with reference to FIG. 2, according to one or more embodiments of the invention.

During the selection step 22, the configuring device 2 selects, on the basis of the reward associated with each dataset 18, a dataset 18 from the set of datasets 18 stored in the memory 16.

Then, in the training step 24, the configuring device 2 trains an artificial intelligence model on the basis of the selected dataset 18. In this way, an experimental artificial intelligence model 20 is obtained.

Then, in the calculation step 26, the configuring device 2 calculates the experimental accuracy score PE of the experimental artificial intelligence model 20.

Then, in the configuration step 28, the configuring device 2 configures the processing chain 4 according to the determined experimental accuracy score PE.

More precisely, depending on the result of the comparison, the configuring device 2:
issues a command to either replace or not replace the current artificial intelligence model 12 with the experimental artificial intelligence model 20 in the prediction stage 10; and
updates the reward associated with the selected dataset 18.

Furthermore, the input data 6, representative of the state of the monitored environment 9, is routed to the processing chain 4 (for determining the current predicted state of the monitored environment 9) and to the configuring device 2.

Advantageously, the configuring device 2 enriches the test data 14 over time, by implementing the enrichment step 30.

More precisely, after at least one observation of the actual state of the monitored environment 9, the configuring device 2 compares the current predicted state of the monitored environment 9 with the actual state of the monitored environment.

Furthermore, the configuring device 2 is configured to update the test data 14 based on a comparison result. In particular, the configuring device 2 enriches the test data by including the input data 6 on the basis of which the current predicted state of the monitored environment 9 has been determined, together with a label representative of whether the prediction is correct or incorrect.

In this way, the test data 14 is enriched, so as to optimize the choice of artificial intelligence model implemented by the processing chain 4.

Advantageously, the configuring device 2 generates datasets 18 over time, by implementing the generation step 32, in order to achieve increasingly efficient trained artificial intelligence models.

More precisely, after at least one observation of the actual state of the monitored environment 9, the configuring device 2 compares the current predicted state of the monitored environment 9 with the actual state of the monitored environment 9.

Furthermore, in the event of a mismatch between the current predicted state and the actual state of the monitored environment 9, the configuring device 2 modifies the current training dataset to include the input data 6 on the basis of which the current predicted state was determined, associated with a label representative of whether the prediction was correct or incorrect (that is representative of a match or mismatch between the current predicted state and the actual observed state).

In this way, a new dataset 18 is obtained, on the basis of which an artificial intelligence model can be trained during the training step 24.

Of course, the one or more embodiments of the invention are not limited to the examples that have just been described.

1. A method for configuring a data processing chain, the data processing chain comprising a prediction stage implementing a current artificial intelligence model, previously trained based on a training dataset, to predict an anomaly in a monitored environment equipped with at least one sensor, from input data received from each sensor of said at least one sensor, the current artificial intelligence model being associated with a current accuracy score, representative of a match between, on one hand, a first predicted state of the monitored environment, determined by the current artificial intelligence model from test data dependent on the input data, and, on another hand, an actual state of the monitored environment for said test data, the method being computer-implemented and comprising:
an implementation of a reinforcement algorithm comprising the steps of:
selecting a dataset from a set of datasets stored in a memory, according to a reward associated with each data from said set of datasets;
training an artificial intelligence model based on the dataset that is selected to obtain an experimental artificial intelligence model;
calculating an experimental accuracy score of the experimental artificial intelligence model, representative of a match between,
on one hand, a second predicted state of the monitored environment, determined by the experimental artificial intelligence model from the test data, and,
on another hand, the actual state of the monitored environment for the test data; and
based on a result of a comparison between the current accuracy score and the experimental accuracy score,
either replacing or not replacing the current artificial intelligence model with the experimental artificial intelligence model in the prediction stage; and
updating the reward associated with the dataset that is selected.

2. The method according to claim 1, wherein, if the experimental accuracy score is higher than the current accuracy score,
the current artificial intelligence model is replaced by the experimental artificial intelligence model; and
the updating of the reward associated with the dataset that is selected is an increase of said reward.

3. The method according to claim 1, wherein, if the experimental accuracy score is lower than the current accuracy score,
the current artificial intelligence model is not replaced by the experimental artificial intelligence model;
the updating of the reward associated with the dataset that is selected is a decrease of said reward.

4. The method according to claim 1, wherein the dataset that is selected is a dataset associated with a maximum reward.

5. The method according to claim 1, further comprising
comparing a current predicted state of the monitored environment, predicted by the current artificial intelligence model from the input data, with the actual state of the monitored environment; and
updating the test data based on a comparison result.

6. The method according to claim 5, wherein the updating the test data comprises adding to the test data some or all of the input data from which the current predicted state was determined, together with a label representative of whether a prediction is correct or incorrect.

7. The method according to claim 1, further comprising
comparing a current predicted state of the monitored environment, predicted by the current artificial intelligence model from the input data, with the actual state of the monitored environment;
in an event of a discrepancy between the current predicted state and the actual state of the monitored environment, creating an additional dataset by modifying the dataset based on which the current artificial intelligence model was trained, from the current predicted state and the actual state of the monitored environment; and
storing the additional dataset that is created in said memory.

8. The method according to claim 7, wherein the additional dataset that is created comprises data of the dataset based on which the current artificial intelligence model has been trained, to which has been added the input data from which the current predicted state has been determined, associated with a label representative of whether a prediction is correct or incorrect.

9. The method according to claim 7, wherein, on creation, the additional dataset that is created is associated with a reward having a value greater than the value of the reward associated with each other dataset of the set of datasets stored in the memory.

10. The method according to claim 1, further comprising
selecting at least some of the input data, preferably by implementing a feature selection process, to generate at least one additional dataset; and
storing the at least one additional dataset that is generated in the memory.

11. The method according to claim 1, wherein the reinforcement algorithm is a Q-learning algorithm, a Deep Q-Learning algorithm or a neural network.

12. A non-transitory computer program comprising executable instructions which, when executed by a computer, implement claim a method for configuring a data processing chain, the data processing chain comprising a prediction stage implementing a current artificial intelligence model, previously trained based on a training dataset, to predict an anomaly in a monitored environment equipped with at least one sensor, from input data received from each sensor of said at least one sensor, the current artificial intelligence model being associated with a current accuracy score, representative of a match between, on one hand, a first predicted state of the monitored environment, determined by the current artificial intelligence model from test data dependent on the input data, and, on another hand, an actual state of the monitored environment for said test data, the method being computer-implemented and comprising:
an implementation of a reinforcement algorithm comprising
selecting a dataset from a set of datasets stored in a memory, according to a reward associated with each data from said set of datasets;
training an artificial intelligence model based on the dataset that is selected to obtain an experimental artificial intelligence model;
calculating an experimental accuracy score of the experimental artificial intelligence model, representative of a match between,
on one hand, a second predicted state of the monitored environment, determined by the experimental artificial intelligence model from the test data, and,
on another hand, the actual state of the monitored environment for the test data; and
based on a result of a comparison between the current accuracy score and the experimental accuracy score,
either replacing or not replacing the current artificial intelligence model with the experimental artificial intelligence model in the prediction stage; and
updating the reward associated with the dataset that is selected.

13. A device that configures a data processing chain is proposed, the data processing chain comprising a prediction stage implementing a current artificial intelligence model, previously trained based on a training dataset, to predict an anomaly in a monitored environment equipped with at least one sensor, from input data received from each sensor of said at least one sensor, the current artificial intelligence model being associated with a current accuracy score, representative of a match between, on one hand, a first predicted state of the monitored environment, determined by the current artificial intelligence model from test data dependent on the input data, and, on another hand, an actual state of the monitored environment for said test data, the device comprising:
a memory; and
a processor configured to implement a reinforcement algorithm comprising
selecting a dataset from a set of datasets stored in said memory, according to a reward associated with each dataset of said set of datasets;
training an artificial intelligence model based on the dataset that is selected to obtain an experimental artificial intelligence model;
calculating an experimental accuracy score of the experimental artificial intelligence model, representative of a match between,
on one hand, a second predicted state of the monitored environment, determined by the experimental artificial intelligence model from the test data, and,
on another hand, the actual state of the monitored environment for the test data; and
based on a result of a comparison between the current accuracy score and the experimental accuracy score,
either replacing or not replacing the current artificial intelligence model with the experimental artificial intelligence model in the prediction stage; and
updating the reward associated with the dataset that is selected.
